(19) United States
(12) Patent Application Publication
(10) Pub. No.: US 2015/0271619 A1
(43) Pub. Date: Sep. 24, 2015

(54) Processing Audio or Video Signals Captured by Multiple Devices

(71) Applicant: Dolby Laboratories Licensing Corporation, San Francisco, CA (US)

(72) Inventors: Xuejing Sun, Beijing (CN); Taoran Lu, Santa Clara, CA (US); Peng Yin, Ithaca, NY (US)

(73) Assignee: DOLBY LABORATORIES LICENSING CORPORATION, San Francisco, CA (US)

(21) Appl. No.: 14/658,565

(22) Filed: Mar. 16, 2015

Related U.S. Application Data
(60) Provisional application No. 61/980,700, filed on Apr. 17, 2014.

(30) Foreign Application Priority Data
Mar. 21, 2014 (CN) 201410108005.6

(51) Int. Cl. H04S 3/00; H04N 13/00

(52) U.S. Cl. CPC H04S 3/008; H04N 13/0007

(57) ABSTRACT

Embodiments of the present disclosure relate to processing audio or video signals captured by multiple devices. An apparatus for processing video and audio signals includes an estimating unit and a processing unit. The estimating unit may estimate at least one aspect of an array at least based on at least one video or audio signal captured respectively by at least one of portable devices arranged in an array. The processing unit may apply the aspect at least based on video to a process of generating a surround sound signal via the array, or apply the aspect at least based on audio to a process of generating a combined video signal via the array. With cross-referencing visual or acoustic hints, an improvement can be achieved in generating an audio or video signal.

### CROSS REFERENCE TO RELATED APPLICATIONS

This application claims the benefit of priority to Chinese Patent Application No. 201410108005.6 filed Mar. 21, 2014 and U.S. Provisional Application No. 61/980,700 filed Apr. 17, 2014 which is incorporated herein by reference in its entirety.

### TECHNICAL FIELD

The present application relates to audio and video signal processing. More specifically, embodiments of the present invention relate to processing audio or video signals captured by multiple devices.

### BACKGROUND

Microphones and cameras have been well known as devices for capturing audio and video signals. Various techniques have been proposed to improve presentation of captured audio or video signals. In some of these techniques, multiple devices are disposed to record the same event, and audio or video signals captured by the devices are processed so as to achieve improved presentation of the event. Examples of such techniques include surround round, 3-dimensional (3D) video, and multi-view video.

In an example of surround sound, a plurality of microphones is arranged in an array to record an event. Audio signals are captured by the microphones and are processed into signals equivalent to the outputs which would be obtained from a plurality of coincident microphones. The coincident microphones refer to two or more microphones having same or different directional characteristics but located at the same location.

In an example of 3D video, two cameras are arranged to record an event, so as to generate two offset images for each frame which are present separately to the left and right eye of the viewer.

In an example of multi-view video, several cameras are placed around the scene to capture views necessary to allow a high quality rendering of the scene from any angle. In general, the captured views are compressed via multi-view video compression (MVC) for transmission. Then viewers' viewing devices may access the relevant views to interpolate new views.

### SUMMARY

According to an embodiment of the present disclosure, an apparatus for processing video and audio signals includes an estimating unit and a processing unit. The estimating unit may estimate at least one aspect of an array at least based on at least one video or audio signal captured respectively by at least one of portable devices arranged in the array. The processing unit may apply the aspect at least based on video to a process of generating a surround sound signal via the array, or apply the aspect at least based on audio to a process of generating a combined video signal via the array.

According to an embodiment of the present disclosure, a system for generating a surround sound signal includes more than one portable devices and a processing device. The portable devices are arranged in an array. One of the portable devices includes an estimating unit. The estimating unit may identify at least one visual object corresponding to at least one another of the portable devices from a video signal captured by the portable device. Further, the estimating unit may determine at least one distance among the portable device and the at least one another of the portable devices based on the identified visual object. The processing device may determine, based on the determined distance, at least one parameter for configuring a process of generating a surround sound signal from audio signals captured by the array.

According to an embodiment of the present disclosure, a portable device includes a camera, measuring unit and an outputting unit. The measuring unit may identify at least one visual object corresponding to at least one another portable device from a video signal captured through the camera. Further, the measuring unit may determine at least one distance among the portable devices based on the identified visual object. The distance may be outputted by the outputting unit.

According to an embodiment of the present disclosure, a system for generating a 3D video signal includes a first portable device and a second portable device. The first portable device may capture a first video signal. The second portable device may capture a second video signal. The first portable device may include a measuring unit and a presenting unit. The measuring unit may measure a distance between the first portable device and the second portable device via acoustic ranging. The presenting unit may present the distance.

According to an embodiment of the present disclosure, a system for generating a high dynamic range (HDR) video or image signal includes more than one portable devices and a processing device. The portable devices may capture video or image signals. The processing device may generate the HDR video or image signal from the video or image signals. For each of at least one pair of the portable devices, one of the paired portable devices may include a measuring unit which can measure a distance between the paired portable devices via acoustic ranging. The processing device may correct the geometric distortion caused by difference in location between paired portable devices based on the distance.

According to an embodiment of the present disclosure, there is provided a method of processing video and audio signals. According to the method, at least one video or audio signal captured respectively by at least one of portable devices arranged in an array is acquired. At least one aspect of the array is estimated at least based on the video or audio signal. Then the aspect at least based on video is applied to a process of generating a surround sound signal via the array, or the aspect at least based on audio is applied to a process of generating a combined video signal via the array.

According to an embodiment of the present disclosure, there is provided a method of generating a 3D video signal. According to the method, a distance between a first portable device and a second portable device is measured via acoustic ranging. Then the distance is presented.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF DRAWINGS

The present invention is illustrated by way of example, and not by way of limitation, in the figures of the accompanying drawings and in which like reference numerals refer to similar elements and in which:

FIG. 1 is a flow chart for illustrating a method of processing video and audio signals according to an embodiment of the present disclosure;

FIG. 2 is a schematic view for illustrating an example arrangement of array for generating a surround sound signal according to an embodiment of the present disclosure;

FIG. 3 is a schematic view for illustrating an example arrangement of array for generating a 3D video signal according to an embodiment of the present disclosure;

FIG. 4 is a block diagram illustrating the structure of an apparatus for processing video and audio signals according to an embodiment of the present disclosure;

FIG. 5 is a block diagram illustrating the structure of an apparatus for generating a surround sound signal according to a further embodiment of the apparatus;

FIG. 6 is a schematic view for illustrating the coverage of the array as illustrated in FIG. 2;

FIG. 7 is a flow chart for illustrating a method of generating a surround sound signal according to an embodiment of the present disclosure;

FIG. 8 is a flow chart for illustrating a method of generating a surround sound signal according to an embodiment of the present disclosure;

FIG. 9 is a flow chart for illustrating a method of generating a surround sound signal according to an embodiment of the present disclosure;

FIG. 10 is a block diagram for illustrating the structure of a system for generating a surround sound signal according to an embodiment of the present disclosure;

FIG. 11 is a flow chart for illustrating a method of generating a surround sound signal according to an embodiment of the present disclosure;

FIG. 12 is a schematic view for illustrating an example presentation of visual marks and the video signal;

FIG. 13 is a flow chart for illustrating a method of generating a surround sound signal according to an embodiment of the present disclosure;

FIG. 14 is a block diagram for illustrating a system for generating an HDR video or image signal according to an embodiment of the present disclosure;

FIG. 15 is a block diagram illustrating an exemplary system for implementing the aspects of the present invention.

### DETAILED DESCRIPTION

The embodiments of the present invention are below described by referring to the drawings. It is to be noted that, for purpose of clarity, representations and descriptions about those components and processes known by those skilled in the art but unrelated to the present invention are omitted in the drawings and the description.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, microcode, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wired line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

To improve the presentation of a recorded event, multiple devices are disposed to record the event. In general, the devices are arranged in an array, and captured audio or video signals are processed based on one or more aspects of the array in order to produce expected outcome. The aspects may include, but not limited to, (1) relative position relation between the devices in the array, such as distance between the devices; (2) relative position relation between the subject and the array, such as distance between the subject and the array, and location of the subject relative to the array; and (3) parameters of the devices, such as directivity of the devices and quality of the captured signals.

With the development of technology, devices for capturing audio or video signals have been incorporated into portable devices such as mobile phones, tablets, media players, and game consoles. Some of the portable devices have also been equipped with audio and/or video processing capabilities. Inventors have realized that such portable devices can function as the capturing devices arranged in the array. However, inventors have also realized that, because most portable devices are usually not designed to be mounted in an array, but are initially designed for handhold usage, relevant aspects of the array may be difficult to determine or control, if the portable devices are disposed in the array.

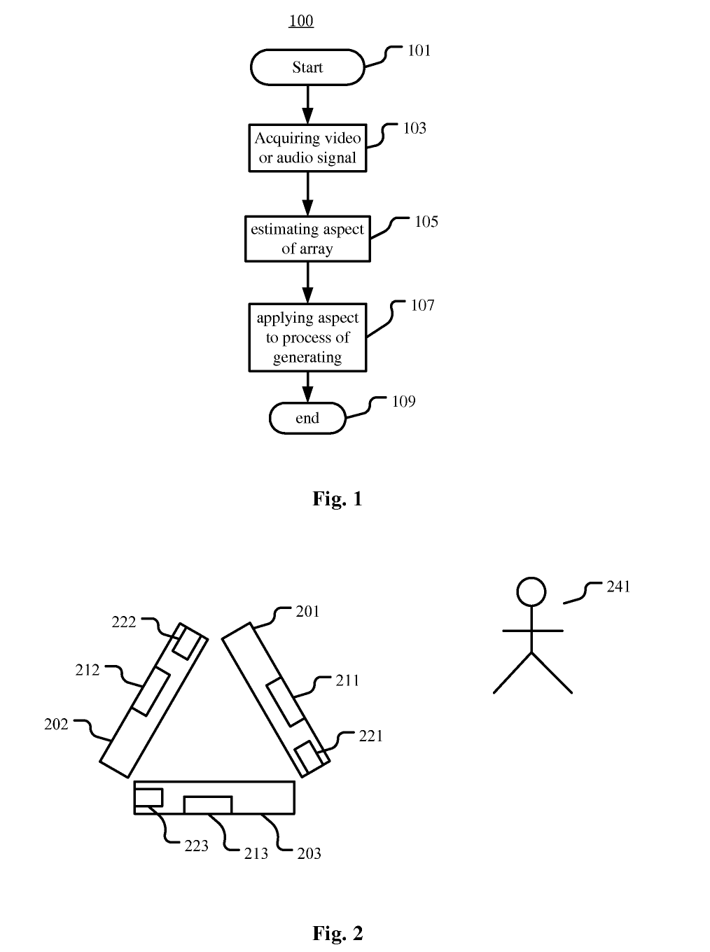

FIG. 1 is a flow chart for illustrating a method 100 of processing video and audio signals according to an embodiment of the present disclosure, where acoustic or visual hint is cross-referenced in video or audio signal processing, for purpose of dealing with the difficulty.

As illustrated in FIG. 1, the method 100 starts from step 101. At step 103, at least one video or audio signal is acquired. The signal is captured respectively by at least one of portable devices arranged in an array. At step 105, at least one aspect of the array is estimated at least based on the video or audio signal. At step 107, the aspect at least based on video is applied to a process of generating a surround sound signal via the array, or the aspect at least based on audio is applied to a process of generating a combined video signal via the array. Then the method 100 ends at step 109.

Depending on requirements of specific applications, the array may include any plural number of portable devices each for capturing an audio signal, a video signal, or an audio signal and a video signal. For each application, the requirement depends on how to generate an audio or video signal for presentation and determines the number of portable devices to form an array for recording an event. Some of aspects which affect the process of generating may be set or determined in advance by assuming that these aspects are available and stable, other of the aspects may be estimated based on acoustic or visual hints contained in the audio or video signals captured by the portable devices. The number of audio or video signals acquired for estimating depends on how many audio or video hints are to be exploited to determine one or more aspects of the array or how reliable the aspects to be estimated are expected to be.

FIG. 2 is a schematic view for illustrating an example arrangement of array for generating a surround sound signal according to an embodiment of the present disclosure. As illustrated in FIG. 2, portable devices 201, 202 and 203 are arranged in an array to record sound emitted from a subject 241. As a result of recording, video signals are captured by cameras 211, 212 and 213 respectively located in the portable devices 201, 202 and 203. These video signals are processed to estimate a relative position relation between the subject 241 and the array as an aspect. As another result of recording, audio signals are captured by microphones 221, 222 and 223 respectively located in the portable devices 201, 202 and 203. The audio signals may be processed to generate a surround sound signal on a horizontal plane, for example, an Ambisonics signal in B-format. In the process of generating, the estimated relative position relation is applied to determine a nominal front of the surround sound signal. In this example, the Ambisonics technique requires at least three microphones 221, 222 and 223, and thus three portable devices 201, 202 and 203. Aspects such as relative position relations among the microphones 221, 222 and 223 may be set or determined in advance based on the expected arrangement of the portable devices 201, 202 and 203. Compared with estimating the relative position relation between the subject and the array based on all the video signals captured by the portable devices 201, 202 and 203 with a higher reliability, it is possible to perform the process of estimating on the video signals captured by a part of the portable devices 201, 202 and 203. This can provide a chance to estimate an exact relative position relation, although with a lower reliability. In this case, there is no need to include the camera function for the estimating purpose in the other portable devices.

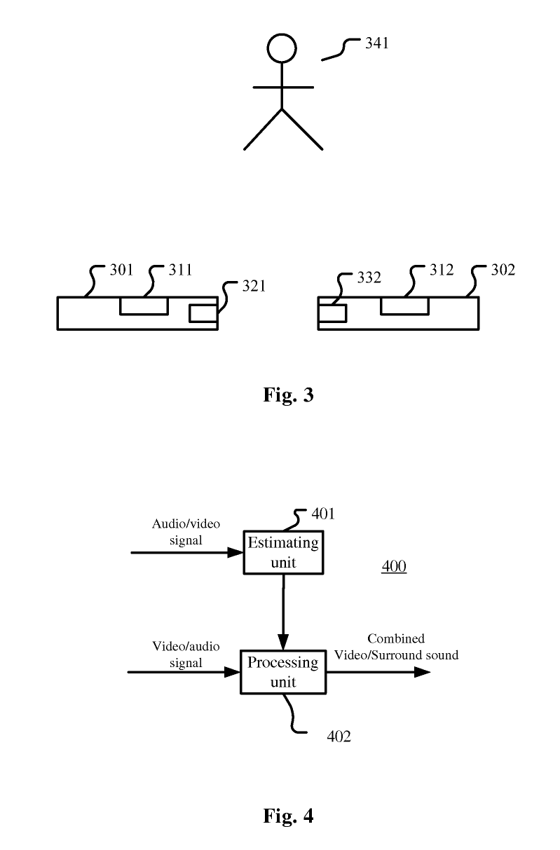

FIG. 3 is a schematic view for illustrating an example arrangement of array for generating a 3D video signal according to an embodiment of the present disclosure. As illustrated in FIG. 3, portable devices 301 and 302 are arranged in an array to record a subject 341. The portable device 302 includes a speaker 332 for emitting a sound for acoustic ranging. The portable device 301 includes a microphone 321 for capturing the sound for acoustic ranging. The distance between cameras 311 and 312 respectively located in the portable devices 301 and 302 may be measured as the acoustic distance. Various acoustic ranging techniques may be used for this purpose. An example technique can be found in U.S. Pat. No. 7,729,204. Alternatively, relative position relations between the portable devices 301 and 302, between the camera 311 and the microphone 321, and between the camera 312 and the speaker 332 may be considered to compensate offset between the acoustic distance and the actual distance between the cameras 311 and 312. Considering that the portable devices 301 and 302 are not fixed, this distance may be measured continuously or regularly. Video signals are captured by the cameras 311 and 312 respectively. In generating a 3D video signal, these video signals are processed based on the distance to keep consistence of the disparity or depth of 3D video over time. In this example, the 3D video technique requires two cameras 311 and 312, and thus two portable devices 301 and 302. In this example, the acoustic ranging is performed with the portable device 301 as the receiver. In addition, it is possible to perform another acoustic ranging with the portable device 302 as the receiver to improve the reliability of the measurement.

Depending on specific applications, audio or video signals captured by different portable devices are acquired to perform the function of estimating and the function of applying. In this case, one or both of the function of estimating and the function of applying may be entirely or partially allocated to one of the portable devices, or an apparatus, for example, a server, in addition to the portable devices.

The captured signals from different portable devices may be synchronized with a common clock directly or indirectly through a synchronization protocol. For example, the captured signals may be labeled with time stamps synchronized to a common clock or to local clocks with definite offsets from the common clock.

FIG. 4 is a block diagram illustrating the structure of an apparatus 400 for processing video and audio signals according to an embodiment of the present disclosure, where the function of estimating and the function of applying are allocated to the apparatus. As illustrated in FIG. 4, the apparatus 400 includes an estimating unit 401 and a processing unit 402. The estimating unit 401 is configured to estimate at least one aspect of an array including more than one portable devices at least based on video or audio signals captured by some or all of the portable devices. The processing unit 402 is configured to apply the aspect at least based on video to a process of generating a surround sound signal via the array, or to apply the aspect at least based on audio to a process of generating a combined video signal via the array.

The apparatus 400 may be implemented as one (also named as master device) of the portable devices in the array. In this case, some or all of the video or audio signals required for the estimation may be captured by the master device, or may be captured by other portable devices and transmitted to the master device. Also, the video or audio signals required for the generation and captured by other portable devices may be directly or indirectly transmitted to the master device.

The apparatus 400 may also be implemented as a device other than the portable device in the array. In this case, the video or audio signals required for the estimation may be directly or indirectly transmitted or delivered to the apparatus 400, or any location accessible to the apparatus 400. Also, the video or audio signals required for the generation and captured by the portable devices may be directly or indirectly transmitted to the apparatus 400.

Further embodiments will be described in connection with applications of surround sound, 3D video, high dynamic range (HDR) video or image, and multi-view video respectively in the following.

### Surround Sound—Managing Nominal Front

Surround sound is a technique for enriching the sound reproduction quality of an audio source with additional audio channels from speakers that surround the listener. The technique enhances the perception of sound spatialization so as to provide immersive listening experience by exploiting a listeners ability to identify the location or origin of a detected sound in direction and distance. In the embodiments of the present disclosure, the surround sound signal may be generated through approaches of (1) processing the audio with psychoacoustic sound localization methods to simulate a two-dimensional (2D) sound field with headphones, or (2) reconstructing the recorded sound field wave fronts within the listening space based on Huygens' principle. Ambisonics, also based on Huygens' principle, is an efficient spatial audio recording technique to provide excellent soundfield and source localization recoverability. Specific embodiments relating to generation of the surround sound signal will be illustrated in connection with the Ambisonics technique. Those skilled in the art can understand that other surround sound techniques are also applicable to the embodiments of the present disclosure.

In these surround sound techniques, a nominal front is assumed in generating the surround sound signal. In an Ambisonics-based example, the nominal front may be assumed as zero azimuth relative to the array in a polar coordinate system with the geometric center of the array as the origin. Sounds coming from the nominal front can be perceived by a listener as coming from his/her front during surround sound playback. It is desirable to have the target sound source, for example, one or more performers on the stage, being perceived as coming from the front, because this is the most natural listening condition. However, due to the ad hoc nature of the array of portable devices, it is rather cumbersome to arrange the portable devices to establish or maintain a state where the nominal front coincides with the target sound source. For example, in the array illustrated in FIG. 2, if the nominal front is assumed as the orientation of the camera 213, sound from the subject 241 will not be perceived by the listener as coming from his/her front during surround sound playback.

### Embodiments Based on Visual Hints

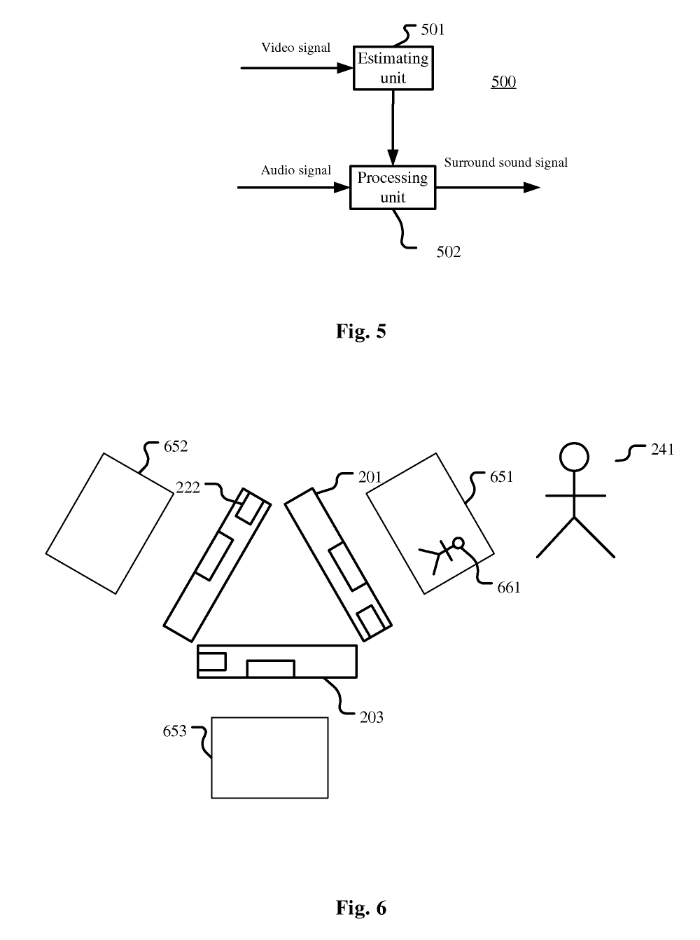

FIG. 5 is a block diagram illustrating the structure of an apparatus 500 for generating a surround sound signal according to a further embodiment of the apparatus 400. As illustrated in FIG. 5, the apparatus 500 includes an estimating unit 501 and a processing unit 502.

The estimating unit 501 is configured to identify a sound source from at least one video signal captured by the array through recording an event, and determine a position relation of the array relative to the sound source. During recording the event, one or more of the portable devices in the array may capture at least one video signal. There is a possibility (also called video-based possibility) that one video signal includes one or more visual objects corresponding to the target sound source. Depending on the arrangement of the array and the configuration of cameras in the portable devices which are operable to capture video signals, if more scenes around the array are covered by the cameras, the possibility that one video signal includes one or more visual objects corresponding to the target sound source is higher. FIG. 6 is a schematic view for illustrating the coverage of the array as illustrated in FIG. 2. In FIG. 6, blocks 651, 652 and 653 respectively represent video signals captured by imaging devices in the portable devices 201, 202 and 203. In the situation as illustrated in FIG. 6, the video signal 651 includes a visual object 661 corresponding to the subject 241. It is possible to identify the sound source by using the possibility provided through the video signal. Various approaches may be used to identify a sound source from a video signal.

In a further embodiment, the estimating unit 501 may estimate a possibility that a visual object in the video signal matches at least one audio object in the audio signal captured by the same portable device, and identify the sound source by regarding a region covering the visual object in the video signal having the higher possibility as corresponding to the sound source. Specific method of identifying the matching can evaluate the possibility. For example, reliability of matching can be calculated.

In an example, the estimating unit 501 may identify a visual object (e.g., visual object 661) matching one of a set of subjects that are likely to act as sound sources, that is, matching one or more audio objects in the audio signal, through a pattern recognizing method. For example, the set may include human or music instruments. Also, audio objects may be classified into sounds produced by various types of subjects such as human or music instruments. A visual object matching one of a set of subjects is also called as a particular visual object.

In another example, correlation between audio objects in an audio signal and visual objects in a video signal may be exploited to identify a sound source, based on an observation that motions of or in a visual object may indicate actions of the sound source which can cause activities of sounding. In this example, the matching may be identified by applying a joint audio-video multimodal object analysis. As an example of the joint audio-video multimodal object analysis, the method described in And H. Izadinia, I. Saleemi, and M. Shah, “Multimodal Analysis for Identification and Segmentation of Moving-Sounding Objects”, IEEE Transactions on Multimedia may be used.

Matching may be identified from one or more than one video signals. Only the matching with higher possibility, that is, higher than a threshold may be considered in identifying the sound source. If there is more than one matching with higher possibility, the matching with the highest possibility may be considered.

The position relation of the array relative to the sound source may represent where the sound source is located relative to the array. In case that the position of the region covering the visual object relative to the image area of the video signal, the size of the imaging sensor of the camera, the projection relation of the lens system of the camera, and the arrangement of the array are known, the location of the sound source relative to the array (e.g., azimuth) can be derived. Alternatively, the region covering the visual object in the video signal may be identified as always covering the entire image area of the video signal. In this case, the sound source may be identified as being pointed by the orientation of the camera which captures the video signal, or as being faced by the camera.

Referring back to FIG. 5, in generating the surround sound signal corresponding to the event, the processing unit 502 is further configured to set a nominal front of the surround sound signal to the location of the sound source based on the position relation. As described in the above, various surround sound techniques may be used. Specific methods of generating a surround sound signal with the specified nominal front depends on the surround sound technique which is used.

According to the Ambisonics technique, the surround sound signal is a four-channel signal, named B-format, with W-X-Y-Z channels. The W channel contains omnidirectional sound pressure information, while the remaining three channels, X, Y, and Z represent sound velocity information measured over the three according axes in a 3D Cartesian coordinates. Specifically, given a sound source S localized at azimuth φ and elevation θ, an ideal B-format representation of the surround soundfield is:

$$W = \frac{\sqrt{2}}{2} S$$

$$X = cos ϕ \cdot cos θ \cdot S$$

$$Y = sin ϕ \cdot cos θ \cdot S$$

$$Z = sin θ \cdot S$$

Just for sake of simplicity, in the following discussion, only the horizontal W, X, and Y channels are considered while the elevation axis Z will be ignored. It should be noted that the concepts described in the following are also applicable to the scenario where the elevation axis Z is not ignored. A mapping matrix W may be used to map audio signals M1, M2, and M3 captured by portable devices in an array (e.g., portable devices 201, 202 and 203) to W, X, and Y channels as follows:

$$[ \begin{matrix}W \\ X \\ Y\end{matrix} ] = W \times [ \begin{matrix}{M}_{1} \\ {M}_{2} \\ {M}_{3}\end{matrix} ]$$

The mapping matrix W may be preset, or may be associated with a topology of microphones in the array which involves distances between the microphones and spatial relation among the microphones. A topology may be represented by a distance matrix including distances between the microphones. The distance matrix may be reduced in dimension through multidimensional scaling (MDS) analysis or a similar process. It is possible to prepare a set of predefined topologies, each of which is associated with a pre-tuned mapping matrix. If a topology of the microphones is known, comparison between the topology and the predefined topologies is performed. For example, distances between the topology and the predefined topologies are calculated. The predefined topology best matching the topology may be determined and the mapping matrix associated with the determined topology may be used.

In a further embodiment, each mapping matrix may be associated with a specific frequency band. In this case, the mapping matrix may be selected based on the topology and the frequency of the audio signals.

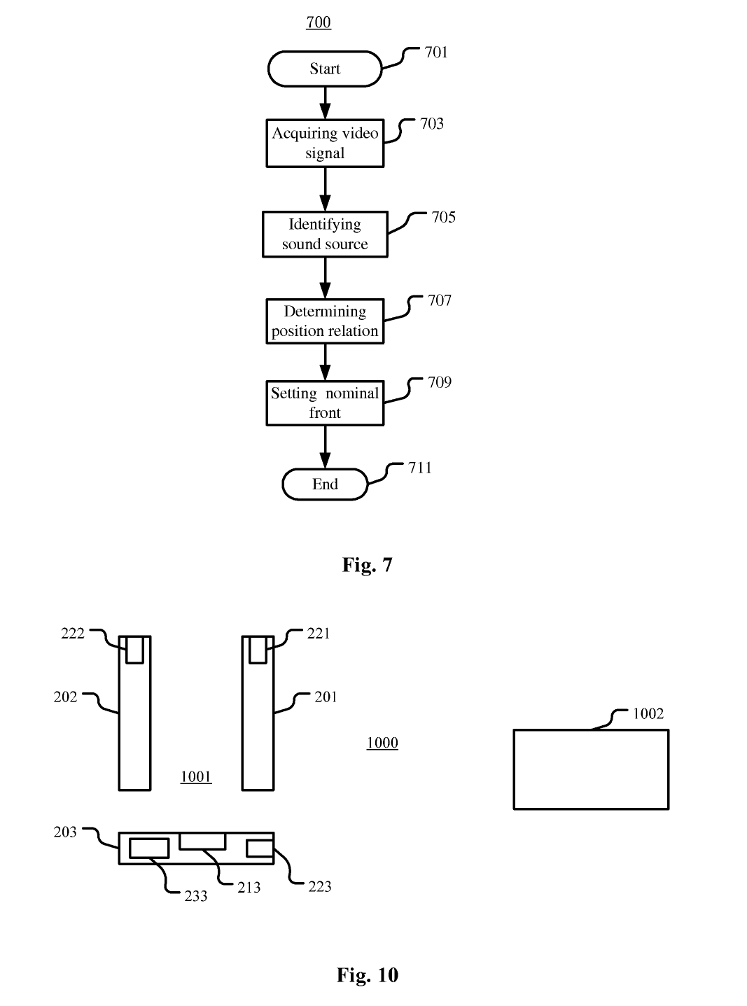

FIG. 7 is a flow chart for illustrating a method 700 of generating a surround sound signal according to an embodiment of the present disclosure.

As illustrated in FIG. 7, the method 700 starts from step 701. At step 703, at least one video signal captured by the array through recording an event is acquired. At step 705, a sound source is identified from the acquired video signal. At step 707, a position relation of the array relative to the sound source is determined Δt step 709, the nominal front of the surround sound signal generated from the audio signals captured via the array is set to the location of the sound source based on the position relation. Then the method 700 ends at step 711.

In a further embodiment of the method 700, the identifying of step 705 may be performed by estimating a possibility that a visual object in the video signal matches at least one audio object in the audio signal captured by the same portable device, and identifying the sound source by regarding a region covering the visual object in the video signal having the higher possibility as corresponding to the sound source.

The sound source may be identified through a pattern recognizing method. Correlation between audio objects in an audio signal and visual objects in a video signal may also be exploited to identify the sound source. For example, a joint audio-video multimodal object analysis may be used.

If none of the cameras covers the target sound source, or if the sound source is not identified accurately enough based on the visual hint, additional hints are necessary to locate the target sound source.

### Embodiments Based on Acoustic and Visual Hints

In a further embodiment of the apparatus 500, besides the functions described in connection with the apparatus 500, the estimating unit 501 is further configured to estimate a direction of arrival (DOA) of sound source based on the audio signals for generating the surround sound signal, and estimate a possibility (also called as audio-based possibility) of the DOA that the sound source is located in the DOA. DOA algorithms like Generalized Cross Correlation with Phase Transform (GCC-PHAT), Steered Response Power-Phase Transform (SRP-PHAT), Multiple Signal Classification (MUSIC), or any other suitable DOA estimation algorithms may be used.

Existence of more than one higher video-based possibility means that it is unable to determine a dominant sound source. The possibility of identifying a wrong sound source may increase in this situation. Absence of any higher video-based possibility means that no sound source can be identified based on the visual hint. In both of these cases, acoustic hint may be used to identify the sound source. DOA is an acoustic hint which can suggest the location of sound source. In general, the sound source is likely located in the direction indicated by the DOA, or around this direction.

Besides the functions described in connection with the apparatus 500, the processing unit 502 further determines if there is more than one higher video-based possibility, or if there is no higher video-based possibility. If so, in case that the audio-based possibility is higher, the processing unit 502 determines a rotating angle θ based on the current nominal front and the DOA, and rotate the soundfield of the surround sound signal so that the nominal front is rotated by the rotating angle.

In an example, it is possible to determine the rotating angle θ such that after the rotation, the nominal front of the surround sound signal coincides with the sound source indicated by the DOA.

In another example, it is possible to determine the rotating angle θ such that after the rotation, the nominal front of the surround sound signal coincides with the most dominant sound source based on energy from the direction indicated by the DOA estimated over time. For example, the rotating angle θ may be find by maximizing the following objective function:

$$θ = arg {max}_{θ} {\sum }_{n = 1}^{N} {E}_{n} cos ( {θ}_{n} - θ ) ,$$

where θₙ and Eₙ represent the short-term estimated DOA and energy for frame n of the generated surround sound signal, respectively, and the total number of frames is N for the whole duration.

The rotating method depends on the specific surround sound technique which is used. In the example of Ambisonics B-format, the soundfield rotation can be achieved by using a standard rotation matrix as follows:

$$[ \begin{matrix}{W}^{′} \\ {X}^{′} \\ {Y}^{′}\end{matrix} ] = [ \begin{matrix}1 & 0 & 0 \\ 0 & cos ( θ ) & - sin ( θ ) \\ 0 & sin ( θ ) & cos ( θ )\end{matrix} ] [ \begin{matrix}W \\ X \\ Y\end{matrix} ]$$

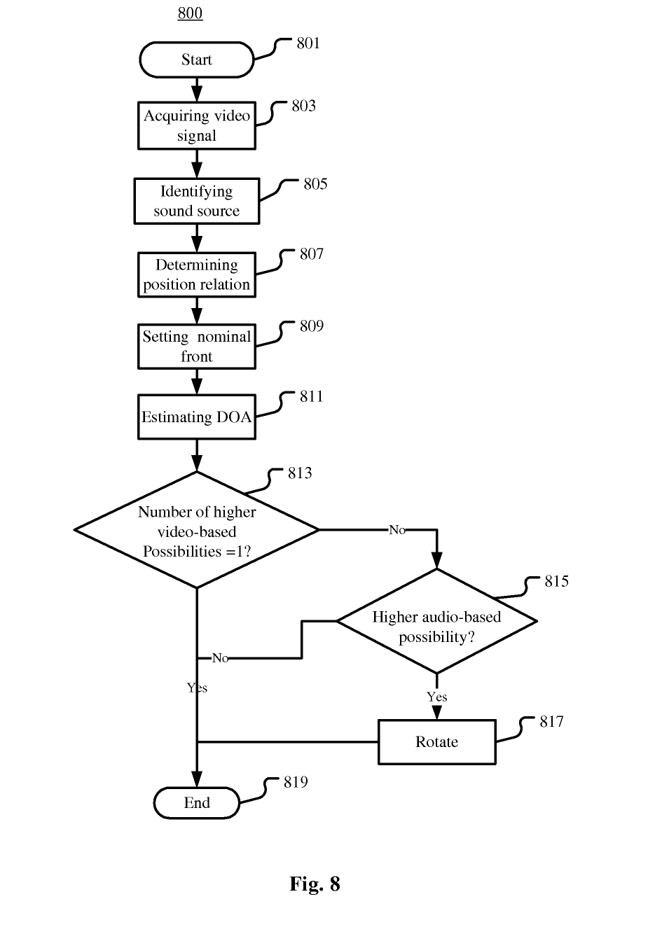

FIG. 8 is a flow chart for illustrating a method 800 of generating a surround sound signal according to an embodiment of the present disclosure.

As illustrated in FIG. 8, the method 800 starts from step 801. Steps 803, 805, 807 and 809 have the same functions as that of steps 703, 705, 707 and 709 respectively, and will be described in detail here. At step 811, a direction of arrival (DOA) of sound source is estimated based on the audio signals for generating the surround sound signal, and a possibility of the DOA that the sound source is located in the DOA is estimated. At step 813, it is determined if there is more than one higher video-based possibility, or if there is no higher video-based possibility (if the number of higher video-based possibilities is not one). If so, at step 815, it is determined if the audio-based possibility is higher. If so, at step 817, a rotating angle θ is determined based on the current nominal front and the DOA, and the soundfield of the surround sound signal is rotated so that the nominal front is rotated by the rotating angle. If not, the method 800 ends at step 819. At step 813, if the result is no, the method 800 ends at step 819.

In a further embodiment of the apparatus 500, besides the functions described in connection with the apparatus 500, the estimating unit 501 is further configured to determine if there is more than one higher video-based possibility, or if there is no higher video-based possibility. If so, the estimating unit 501 estimates a direction of arrival (DOA) of sound source based on the audio signals for generating the surround sound signal, and estimate a possibility of the DOA that the sound source is located in the DOA.

Besides the functions described in connection with the apparatus 500, the processing unit 502 further determines if the audio-based possibility is higher. If so, the processing unit 502 determines a rotating angle θ based on the current nominal front and the DOA, and rotate the soundfield of the surround sound signal so that the nominal front is rotated by the rotating angle.

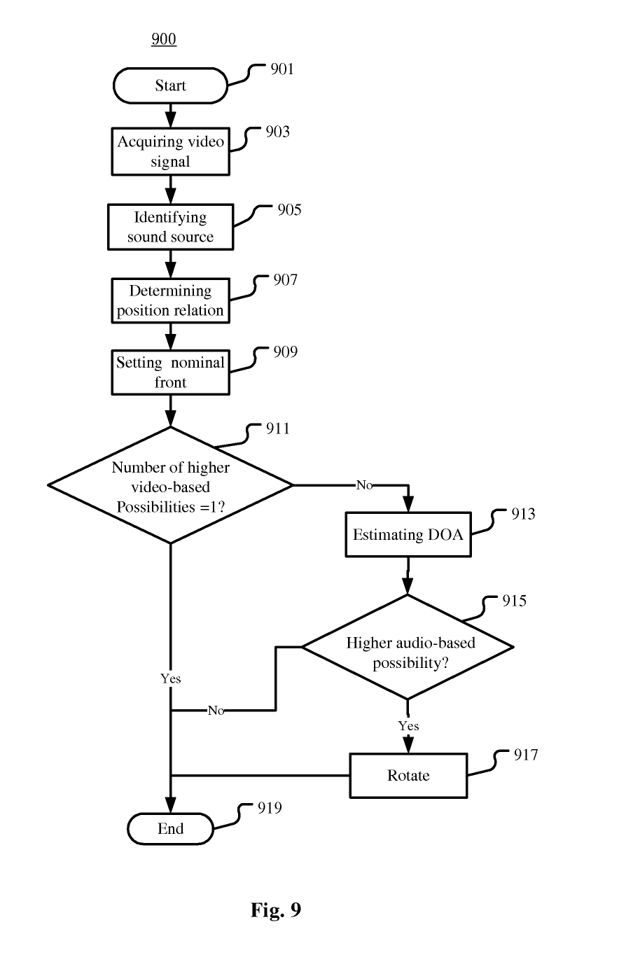

FIG. 9 is a flow chart for illustrating a method 900 of generating a surround sound signal according to an embodiment of the present disclosure.

As illustrated in FIG. 9, the method 900 starts from step 901. Steps 903, 905, 907 and 909 have the same functions as that of steps 703, 705, 707 and 709 respectively, and will be described in detail here. At step 911, it is determined if there is more than one higher video-based possibility, or if there is no higher video-based possibility (if the number of higher video-based possibilities is not one). If so, at step 913, a direction of arrival (DOA) of sound source is estimated based on the audio signals for generating the surround sound signal, and a possibility of the DOA that the sound source is located in the DOA is estimated. At step 915, it is determined if the audio-based possibility is higher. If so, at step 917, a rotating angle θ is determined based on the current nominal front and the DOA, and the soundfield of the surround sound signal is rotated so that the nominal front is rotated by the rotating angle. If not, the method 900 ends at step 919. At step 911, if the result is no, the method 900 ends at step 919.

### Surround Sound—Managing Topology

Video-based hint may also be exploited to measure distances between portable devices in an array, so as to determine the topology of the array.

FIG. 10 is a block diagram for illustrating the structure of a system 1000 for generating a surround sound signal according to an embodiment of the present disclosure.

As illustrated in FIG. 10, the system 1000 includes an array 1001 and a processing device 1002. Portable devices 201, 202 and 203 include microphones 221, 222 and 223 respectively and are arranged in the array 1001. The portable device 203 comprises an estimating unit 233. The estimating unit 233 is configured to identify visual objects corresponding to the portable devices 201 and 202 from a video signal captured by the portable device 203. It should be noted that the video signal comprises pictures captured by the camera. Then the estimating unit 233 determines at least one distance among the portable device 201, 202 and 203 based on the identified visual objects. The distance can be computed given the camera's physical parameters (e.g., focal length, imaging sensor size, and aperture), and the true dimension of the other portable device that appears in the photo, with very simple mathematical computation. These parameters can be predetermined, or acquired from the camera specification and the EXIF tag of the picture, for example.

The portable device 202 may include an outputting unit configured to output the estimated distance to the processing device 1002. The estimated distance may be synchronized with a common clock directly or indirectly through a synchronization protocol, so as to reflect the change in the topology.

The arrangement of the array is not limited to that of the array 1001. Other arrangements may be used as long as one portable device can image other portable devices.

The processing device 1002 is configured to determine, based on the determined distance, at least one parameter for configuring a process of generating a surround sound signal from audio signals captured by the array. The distance can determine the topology of the microphone array. The topology can determine one or more parameters for mapping from the audio signals captured by the array to the surround sound signal. Parameters to be determined depend on the specific surround sound technique which is used. In the example of Ambisonics B-format, the parameters form a mapping matrix. In addition, the processing device 1002 may include the functions of the apparatus described in the section “Surround sound—managing nominal front.”

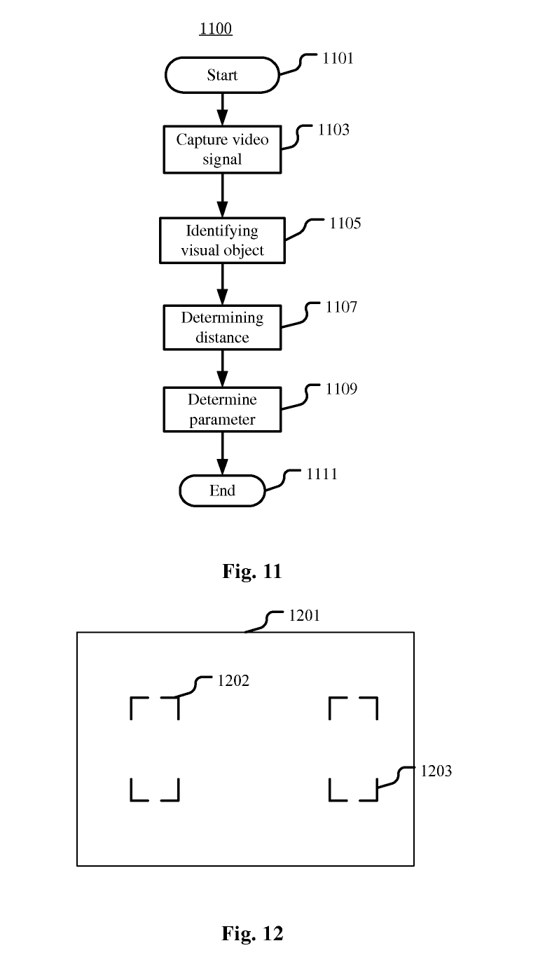

FIG. 11 is a flow chart for illustrating a method 1100 of generating a surround sound signal according to an embodiment of the present disclosure.

As illustrated in FIG. 11, the method 1100 starts from step 1101. At step 1103, a video signal is captured. At step 1105, at least one visual object corresponding to at least one portable device of the array is identified from the video signal. At step 1107, at least one distance among the portable device capturing the video signal and the portable device corresponding to the identified visual object is determined based on the identified visual object. At step 1109, at least one parameter for configuring the process of generating the surround sound signal is determined based on the determined distance. Then the method 1100 ends at step 1111.

In a further embodiment of the system 1000, the estimating unit 233 may be further configured to determine if the ambient acoustic noise is high. If so, the estimating unit 233 performs the operations of identifying one or more visual objects and determining the distances among the portable devices. The portable devices in the array are provided with units required for acoustic ranging among the portable devices. If the ambient acoustic noise is low, the distances may be determined via acoustic ranging.

In a further embodiment, the portable device configured to determine the distance may include a presenting unit for presenting a perceivable signal indicating departure of the distance from a predetermined range. The perceivable signal may be a sound capable of indicating a degree of the departure. Alternatively, the presenting unit may be configured to displaying at least one visual mark each indicating the expected position of a portable device and the video signal on a display of the portable device. FIG. 12 is a schematic view for illustrating an example presentation of visual marks and the video signal in connection with the array 1001. Marks 1202, 1203 and video signal 1201 are presented on the display of the portable device 203. The marks 1202 and 1203 respectively indicate the expected positions of the portable devices 202 and 201.

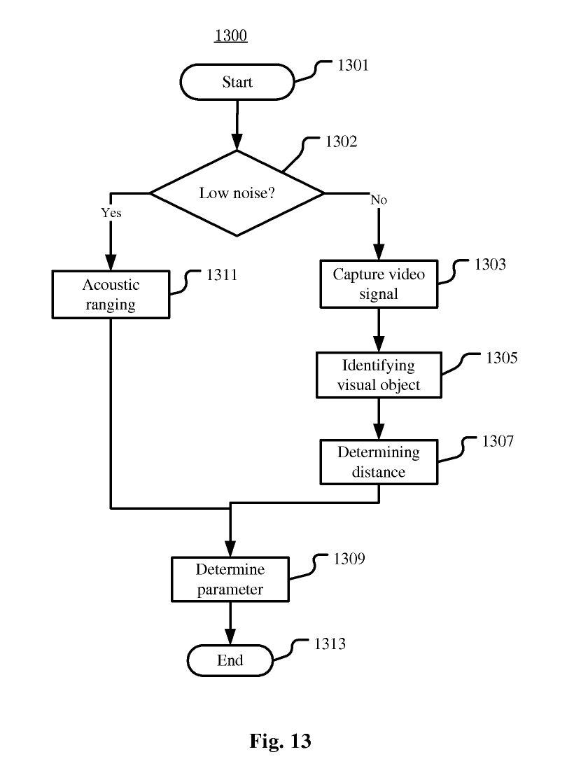

FIG. 13 is a flow chart for illustrating a method 1300 of generating a surround sound signal according to an embodiment of the present disclosure.

As illustrated in FIG. 13, the method 1300 starts from step 1301. Steps 1303, 1305, 1307, 1309 and 1313 have the same functions as that of steps 1103, 1105, 1107, 1109 and 1111 respectively, and will not be described in detail here.

At step 1302, it is determined if the ambient acoustic noise is high. If it is high, the method 1300 proceeds to step 1303. If it is low, at step 1311, at least one distance among the at least one portable device is determined via acoustic ranging, and then the method 1300 proceeds to step 1309.

In a further embodiment of the method 1300, the method further comprises presenting a perceivable signal indicating departure of one of the at least one distance from a predetermined range. The perceivable signal may be a sound capable of indicating a degree of the departure. The perceivable signal may be presented by displaying at least one visual mark each indicating the expected position of a portable device and the video signal for the identifying on a display.

### 3D Video

Referring back to FIG. 3, there is illustrated a system for generating a 3D video signal. The portable devices 301 and 302 are arranged to capture video signal of different views for the 3D video signal. Although not shown in FIG. 3, the portable device 302 includes a measuring unit configured to measure the distance between the portable devices 301 and 302 via acoustic ranging, and a presenting unit configured to present the distance. By measuring and presenting the distance, it can be helpful for users to be aware of the distance between the cameras so as to keep the distance at or near a desired constant.

Further, the presenting unit may present a perceivable signal indicating departure of the distance from a predetermined range.

### High Dynamic Range (HDR) Video or Image

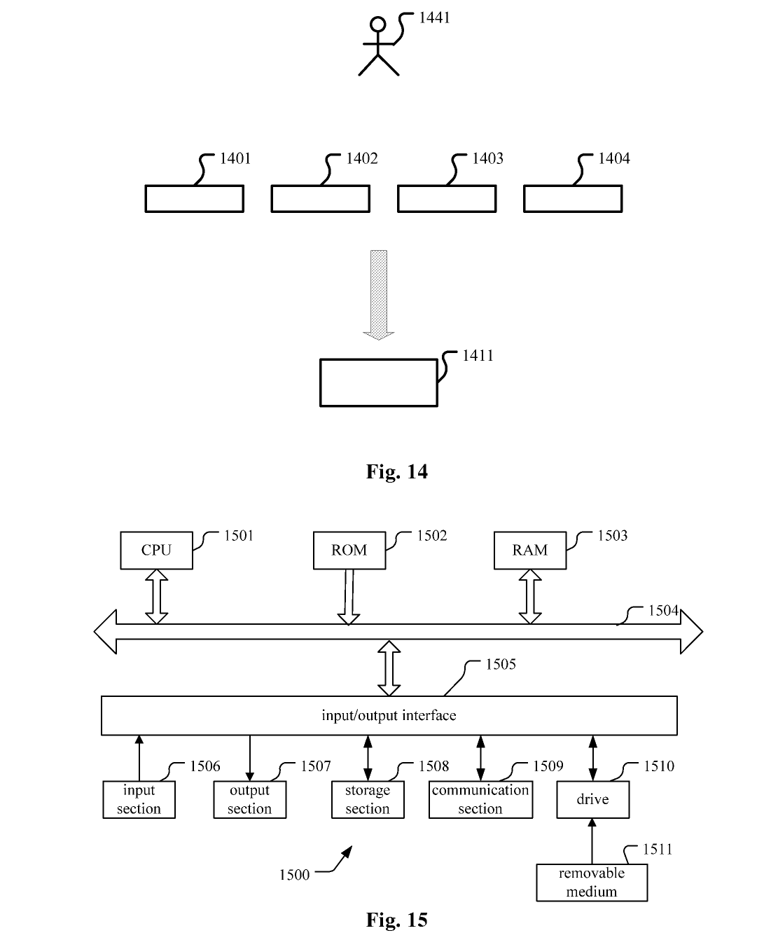

FIG. 14 is a block diagram for illustrating a system for generating an HDR video or image signal according to an embodiment of the present disclosure.

As illustrated in FIG. 14, the system includes portable devices 1401, 1402, 1403 and 1404 configured to capture video or image signals by recording subject 1441. There can be any plural number of portable devices, as long as they are configured to capture video or image signals with different exposure amounts for HDR purpose. The system also includes a processing device 1411. The processing device 1411 is configured to generate the HDR video or image signal from the video or image signals. Distances between the cameras of the portable devices can be used to compute the warping/projection parameters to correct the geometric distortion caused by different camera position, so as to generate video or image signals that would be captured as if the portable devices are located at the same position. In this way, the generated video or image signals are used to generate the HDR video or image signal.

The distance between the portable devices can be measure through the configuration based on acoustic ranging as described in the above.

### Multi-View Video

In a further embodiment of the apparatus 400, the combined video signal is a multi-view video signal in a compression format. The estimating unit 401 is further configured to estimate a position relation between a sound source and the array based on the audio signal, and determine one of the portable devices in the array which has a viewing angle better covering the sound source. The processing unit 402 is further configured to select the view captured by the determined portable device as a base view.

In a further embodiment of the apparatus 400, the combined video signal is a multi-view video signal in a compression format. The estimating unit 401 is further configured to estimate audio signal quality of the portable devices in the array. The processing unit 402 is further configured to select the view captured by the portable device with the best audio signal quality as a base view.

Further, the multi-view video signal may be a transmitted version over a connection. In this situation, the processing unit 401 is further configured to allocate a better bit rate or error protection to the base view.

FIG. 15 is a block diagram illustrating an exemplary system for implementing the aspects of the present invention.

In FIG. 15, a central processing unit (CPU) 1501 performs various processes in accordance with a program stored in a read only memory (ROM) 1502 or a program loaded from a storage section 1508 to a random access memory (RAM) 1503. In the RAM 1503, data required when the CPU 1501 performs the various processes or the like is also stored as required.

The CPU 1501, the ROM 1502 and the RAM 1503 are connected to one another via a bus 1504. An input/output interface 1505 is also connected to the bus 1504.

The following components are connected to the input/output interface 1505: an input section 1506 including a keyboard, a mouse, or the like; an output section 1507 including a display such as a cathode ray tube (CRT), a liquid crystal display (LCD), or the like, and a loudspeaker or the like; the storage section 1508 including a hard disk or the like; and a communication section 1509 including a network interface card such as a LAN card, a modem, or the like. The communication section 1509 performs a communication process via the network such as the internet.

A drive 1510 is also connected to the input/output interface 1505 as required. A removable medium 1511, such as a magnetic disk, an optical disk, a magneto—optical disk, a semiconductor memory, or the like, is mounted on the drive 1510 as required, so that a computer program read therefrom is installed into the storage section 1508 as required.

In the case where the above—described steps and processes are implemented by the software, the program that constitutes the software is installed from the network such as the internet or the storage medium such as the removable medium 1511.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The following exemplary embodiments (each referred to as an “EE”) are described.

EE 1. An apparatus for processing video and audio signals, comprising:

an estimating unit configured to estimate at least one aspect of an array at least based on at least one video or audio signal captured respectively by at least one of portable devices arranged in the array; and

a processing unit configured to apply the aspect at least based on video to a process of generating a surround sound signal via the array, or apply the aspect at least based on audio to a process of generating a combined video signal via the array.

EE 2. The apparatus according to EE 1, wherein

the video signal is captured by recording an event,

the estimating unit is further configured to identify a sound source from the video signal and determine a position relation of the array relative to the sound source, and

the processing unit is further configured to set a nominal front of the surround sound signal corresponding to the event to the location of the sound source based on the position relation.

EE 3. The apparatus according to EE 2, wherein

the estimating unit is further configured to:
for each of the at least one video signal, estimate a first possibility that at least one visual object in the video signal matches at least one audio object in an audio signal, wherein the video signal and the audio signal are captured by the same portable device during recording the event; and
identify the sound source by regarding a region covering the visual object having the higher possibility in the video signal as corresponding to the sound source.

EE 4. The apparatus according to EE 3, wherein the estimating unit is further configured to:

estimate a direction of arrival (DOA) of sound source based on audio signals for generating the surround sound signal; and

estimate a second possibility of the DOA that the sound source is located in the DOA, and

wherein the processing unit is further configured to:

if there are more than one higher first possibilities, or if there is no higher first possibility, in case that the second possibility is higher, determine a rotating angle based on the current nominal front and the DOA, and rotate the soundfield of the surround sound signal so that the nominal front is rotated by the rotating angle.

EE 5. The apparatus according to EE 3, wherein the estimating unit is further configured to:

if there are more than one higher first possibilities, or if there is no higher first possibility, estimate a direction of arrival DOA of sound source based on audio signals for generating the surround sound signal, and

wherein the processing unit is further configured to:

if the DOA has a higher possibility that the sound source is located in the DOA, determine a rotating angle based on the current nominal front and the DOA, and rotate the soundfield of the surround sound signal so that the nominal front is rotated by the rotating angle.

EE 6. The apparatus according to EE 3, wherein the matching is identified by applying a joint audio-video multimodal object analysis.

EE 7. The apparatus according to EE 3, wherein the sound source is identified by regarding the orientation of a camera of the portable device which captures the video signal having the higher possibility as pointing to the sound source.

EE 8. The apparatus according to EE 3, wherein the matching is identified by recognizing a particular visual object as a sound source.

EE 9. The apparatus according to EE 1, wherein

the combined video signal comprises a multi-view video signal in a compression format,

the estimating unit is further configured to estimate a position relation between a sound source and the array based on the audio signal, and determine one of the portable devices in the array which has a viewing angle better covering the sound source, and

the processing unit is further configured to select the view captured by the determined portable device as a base view.

EE 10. The apparatus according to EE 1, wherein

the combined video signal comprises a multi-view video signal in a compression format,

the estimating unit is further configured to estimate audio signal quality of the portable devices in the array, and

the processing unit is further configured to select the view captured by the portable device with the best audio signal quality as a base view.

EE 11. The apparatus according to EE 10 or 11, wherein

the multi-view video signal is a transmitted version over a connection, and

the processing unit is further configured to allocate a better bit rate or error protection to the base view.

EE 12. A system for generating a surround sound signal, comprising:

more than one portable devices arranged in an array, wherein one of the portable devices comprises an estimating unit configured to:
identify at least one visual object corresponding to at least one another of the portable devices from a video signal captured by the portable device; and
determine at least one distance among the portable device and the at least one another of the portable devices based on the identified visual object; and

a processing device configured to determine, based on the determined distance, at least one parameter for configuring a process of generating a surround sound signal from audio signals captured by the array.

EE 13. The system according to EE 12, wherein

the estimating unit is further configured to:
if the ambient acoustic noise is high, identify the at least one visual object and determine the at least one distance, and

wherein each of at least one pair of the portable devices is configured to, if the ambient acoustic noise is low, determine a distance between the pair of the portable devices via acoustic ranging.

EE 14. The system according to EE 12 or 13, wherein for at least one determined distance, a perceivable signal indicating departure of the distance from a predetermined range is presented.

EE 15. The system according to EE 14, wherein the perceivable signal comprises a sound capable of indicating a degree of the departure.

EE 16. The system according to EE 14, wherein the presenting of the perceivable signal comprises displaying at least one visual mark each indicating the expected position of a portable device and the video signal for the identifying on a display.

EE 17. A portable device comprising:

a camera;

an measuring unit configured to identify at least one visual object corresponding to at least one another portable device from a video signal captured through the camera and determine at least one distance among the portable devices based on the identified visual object; and

an outputting unit configured to output the distance.

EE 18. The portable device according to EE 17, further comprising:

a microphone, and

wherein the measuring unit is configured to:
if the ambient acoustic noise is high, identify the at least one visual object and determine the at least one distance; and
if the ambient acoustic noise is low, determine at least one distance among the portable devices via acoustic ranging.

EE 19. The portable device according to EE 17 or 18, further comprising:

a presenting unit configured to present a perceivable signal indicating departure of one of the at least one distance from a predetermined range.

EE 20. The portable device according to EE 19, wherein the perceivable signal comprises a sound capable of indicating a degree of the departure.

EE 21. The portable device according to EE 19, wherein the presenting of the perceivable signal comprises displaying at least one visual mark each indicating the expected position of a portable device and the video signal for the identifying on a display.

EE 22. A system for generating a 3D video signal, comprising:

a first portable device configured to capture a first video signal; and

a second portable device configured to capture a second video signal,

wherein the first portable device comprises:

a measuring unit configured to measure a distance between the first portable device and the second portable device via acoustic ranging, and

a presenting unit configured to present the distance.

EE 23. The system according to EE 22, wherein the presenting unit is further configured to present a perceivable signal indicating departure of the distance from a predetermined range.

EE 24 A system for generating an HDR video or image signal, comprising:

more than one portable devices configured to capture video or image signals; and

a processing device configured to generate the HDR video or image signal from the video or image signals,

wherein for each of at least one pair of the portable devices, one of the paired portable devices comprises a measuring unit configured to measure a distance between the paired portable devices via acoustic ranging, and

the processing device is further configured to correct the geometric distortion caused by difference in location between paired portable devices based on the distance.

EE 25. The system according to EE 24, wherein

the measuring unit is further configured to measure the distance if the ambient acoustic noise is low.

EE 26. The system according to EE 25, wherein

one of the paired portable devices comprises an estimating unit configured to, if the ambient acoustic noise is high, identify a visual object corresponding to another of the paired portable devices from the video signal captured by the portable device, and measure the distance between the paired portable devices based on the identified visual object.

EE 27. The system according to any one of EEs 24-26, wherein

for at least one determined distance, a perceivable signal indicating departure of the distance from a predetermined range is presented.

EE 28. A method of processing video and audio signals, comprising:

acquiring at least one video or audio signal captured respectively by at least one of portable devices arranged in an array;

estimating at least one aspect of the array at least based on the video or audio signal; and

applying the aspect at least based on video to a process of generating a surround sound signal via the array, or applying the aspect at least based on audio to a process of generating a combined video signal via the array.

EE 29. The method according to EE 28, wherein

the video signal is captured by recording an event,

the estimating comprises identifying a sound source from the video signal and determining a position relation of the array relative to the sound source, and

the applying comprises setting a nominal front of the surround sound signal corresponding to the event to the location of the sound source based on the position relation.

EE 30. The method according to EE 29, wherein

the identifying of the sound source comprises:
for each of the at least one video signal, estimating a first possibility that at least one visual object in the video signal matches at least one audio object in an audio signal, wherein the video signal and the audio signal are captured by the same portable device during recording the event; and
identifying the sound source by regarding a region covering the visual object having the higher possibility in the video signal as corresponding to the sound source.

EE 31. The method according to EE 30, wherein the estimating of the aspect comprises:

estimating a direction of arrival (DOA) of sound source based on audio signals for generating the surround sound signal; and

estimating a second possibility of the DOA that the sound source is located in the DOA, and

wherein the applying comprises:

if there are more than one higher first possibilities, or if there is no higher first possibility, in case that the second possibility is higher, determining a rotating angle based on the current nominal front and the DOA, and rotating the soundfield of the surround sound signal so that the nominal front is rotated by the rotating angle.

EE 32. The method according to EE 30, wherein the estimating of the aspect comprises:

if there are more than one higher first possibilities, or if there is no higher first possibility, estimating a direction of arrival DOA of sound source based on audio signals for generating the surround sound signal, and

wherein the applying comprises:

if the DOA has a higher possibility that the sound source is located in the DOA, determining a rotating angle based on the current nominal front and the DOA, and rotating the soundfield of the surround sound signal so that the nominal front is rotated by the rotating angle.

EE 33. The method according to EE 30, wherein the matching is identified by applying a joint audio-video multimodal object analysis.

EE 34. The method according to EE 30, wherein the sound source is identified by regarding the orientation of a camera of the portable device which captures the video signal having the higher possibility as pointing to the sound source.

EE 35. The method according to EE 30, wherein the matching is identified by recognizing a particular visual object as a sound source.

EE 36. The method according to EE 28, wherein

the combined video signal comprises a multi-view video signal in a compression format,

the estimating comprises estimating a position relation between a sound source and the array based on the audio signal, and determining one of the portable devices in the array which has a viewing angle better covering the sound source, and

the applying comprises selecting the view captured by the determined portable device as a base view.

EE 37. The method according to EE 28, wherein

the combined video signal comprises a multi-view video signal in a compression format,

the estimating comprises estimating audio signal quality of the portable devices in the array, and

the applying comprises selecting the view captured by the portable device with the best audio signal quality as a base view.

EE 38. The method according to EE 36 or 37, wherein

the multi-view video signal is a transmitted version over a connection, and

the applying comprises allocating a better bit rate or error protection to the base view.

39. The method according to EE 28, wherein

the estimating comprises identifying at least one visual object corresponding to at least one portable device of the array from one of the at least one video signal and determining at least one distance among the portable device capturing the video signal and the portable device corresponding to the identified visual object, based on the identified visual object, and

the applying comprises determining, based on the determined distance, at least one parameter for configuring the process.

EE 40. The method according to EE 39, wherein

the estimating further comprises:
if the ambient acoustic noise is high, identifying the at least one visual object and determining the at least one distance; and
if the ambient acoustic noise is low, determining at least one distance among the at least one portable device via acoustic ranging.

EE 41. The method according to EE 39 or 40, further comprising presenting a perceivable signal indicating departure of one of the at least one distance from a predetermined range.

EE 42. The method according to EE 41, wherein the perceivable signal comprises a sound capable of indicating a degree of the departure.

EE 43. The method according to EE 41, wherein the presenting of the perceivable signal comprises displaying at least one visual mark each indicating the expected position of a portable device and the video signal for the identifying on a display.

EE 44. The method according to EE 28, wherein

the combined video signal comprises an HDR video or image signal,

the estimating comprises, for each of at least one pair of the portable devices, measuring a distance between the paired portable devices via acoustic ranging; and

the applying comprises correcting the geometric distortion caused by difference in location between the paired portable devices based on the distance.

EE 45. The method according to EE 44, wherein

the estimating further comprises measuring the distance if the ambient acoustic noise is low.

EE 46. The method according to EE 45, wherein

the estimating further comprises, if the ambient acoustic noise is high,
identifying, from the video signal captured by one of the paired portable devices, a visual object corresponding to another portable device in the pair; and
measuring the distance based on the identified visual object, and

the applying comprises correcting the geometric distortion caused by difference in location between portable devices in the array based on the distance.

EE 47. The method according to any one of EEs 44-46, further comprising:

presenting a perceivable signal indicating departure of one of the distance from a predetermined range.

EE 48. A method of generating a 3D video signal, comprising:

measuring a distance between a first portable device and a second portable device via acoustic ranging; and

presenting the distance.

EE 49. The method according to EE 48, wherein the presenting further comprises presenting a perceivable signal indicating departure of the distance from a predetermined range.

We claim:

1. An apparatus for processing video and audio signals, comprising:
an estimating unit configured to estimate at least one aspect of an array at least based on at least one video or audio signal captured respectively by at least one of portable devices arranged in the array; and
a processing unit configured to apply the aspect at least based on video to a process of generating a surround sound signal via the array, or apply the aspect at least based on audio to a process of generating a combined video signal via the array.

2. The apparatus according to claim 1, wherein
the video signal is captured by recording an event,
the estimating unit is further configured to identify a sound source from the video signal and determine a position relation of the array relative to the sound source, and
the processing unit is further configured to set a nominal front of the surround sound signal corresponding to the event to the location of the sound source based on the position relation.

3. The apparatus according to claim 2, wherein
the estimating unit is further configured to:
for each of the at least one video signal, estimate a first possibility that at least one visual object in the video signal matches at least one audio object in an audio signal, wherein the video signal and the audio signal are captured by the same portable device during recording the event; and
identify the sound source by regarding a region covering the visual object having the higher possibility in the video signal as corresponding to the sound source.

4. The apparatus according to claim 3, wherein the estimating unit is further configured to:
estimate a direction of arrival (DOA) of sound source based on audio signals for generating the surround sound signal; and
estimate a second possibility of the DOA that the sound source is located in the DOA, and
wherein the processing unit is further configured to:
if there are more than one higher first possibilities, or if there is no higher first possibility, in case that the second possibility is higher, determine a rotating angle based on the current nominal front and the DOA, and rotate the soundfield of the surround sound signal so that the nominal front is rotated by the rotating angle.

5. The apparatus according to claim 3, wherein the estimating unit is further configured to:
if there are more than one higher first possibilities, or if there is no higher first possibility, estimate a direction of arrival DOA of sound source based on audio signals for generating the surround sound signal, and
wherein the processing unit is further configured to:
if the DOA has a higher possibility that the sound source is located in the DOA, determine a rotating angle based on the current nominal front and the DOA, and rotate the soundfield of the surround sound signal so that the nominal front is rotated by the rotating angle.

6. The apparatus according to claim 1, wherein
the combined video signal comprises a multi-view video signal in a compression format,
the estimating unit is further configured to estimate a position relation between a sound source and the array based on the audio signal, and determine one of the portable devices in the array which has a viewing angle better covering the sound source, and
the processing unit is further configured to select the view captured by the determined portable device as a base view.

7. The apparatus according to claim 1, wherein
the combined video signal comprises a multi-view video signal in a compression format,
the estimating unit is further configured to estimate audio signal quality of the portable devices in the array, and
the processing unit is further configured to select the view captured by the portable device with the best audio signal quality as a base view.

8. A system for generating a surround sound signal, comprising:
more than one portable devices arranged in an array, wherein one of the portable devices comprises an estimating unit configured to:
identify at least one visual object corresponding to at least one another of the portable devices from a video signal captured by the portable device; and
determine at least one distance among the portable device and the at least one another of the portable devices based on the identified visual object; and
a processing device configured to determine, based on the determined distance, at least one parameter for configuring a process of generating a surround sound signal from audio signals captured by the array.

9. The system according to claim 8, wherein
the estimating unit is further configured to:
if the ambient acoustic noise is high, identify the at least one visual object and determine the at least one distance, and
wherein each of at least one pair of the portable devices is configured to, if the ambient acoustic noise is low, determine a distance between the pair of the portable devices via acoustic ranging.

10. A method of processing video and audio signals, comprising:
acquiring at least one video or audio signal captured respectively by at least one of portable devices arranged in an array;
estimating at least one aspect of the array at least based on the video or audio signal; and
applying the aspect at least based on video to a process of generating a surround sound signal via the array, or applying the aspect at least based on audio to a process of generating a combined video signal via the array.

11. The method according to claim 10, wherein
the video signal is captured by recording an event,
the estimating comprises identifying a sound source from the video signal and determining a position relation of the array relative to the sound source, and
the applying comprises setting a nominal front of the surround sound signal corresponding to the event to the location of the sound source based on the position relation.

12. The method according to claim 10, wherein
the combined video signal comprises a multi-view video signal in a compression format,
the estimating comprises estimating a position relation between a sound source and the array based on the audio signal, and determining one of the portable devices in the array which has a viewing angle better covering the sound source, and
the applying comprises selecting the view captured by the determined portable device as a base view.

13. The method according to claim 10, wherein
the combined video signal comprises a multi-view video signal in a compression format,
the estimating comprises estimating audio signal quality of the portable devices in the array, and
the applying comprises selecting the view captured by the portable device with the best audio signal quality as a base view.

14. The method according to claim 10, wherein
the estimating comprises identifying at least one visual object corresponding to at least one portable device of the array from one of the at least one video signal and determining at least one distance among the portable device capturing the video signal and the portable device corresponding to the identified visual object, based on the identified visual object, and
the applying comprises determining, based on the determined distance, at least one parameter for configuring the process.

15. The method according to claim 10, wherein
the combined video signal comprises an HDR video or image signal,
the estimating comprises, for each of at least one pair of the portable devices, measuring a distance between the paired portable devices via acoustic ranging; and
the applying comprises correcting the geometric distortion caused by difference in location between the paired portable devices based on the distance.
